(19) United States
(12) Patent Application Publication
(10) Pub. No.: US 2005/0012735 A1
(43) Pub. Date: Jan. 20, 2005

(54) Method and apparatus for saving power through a look-up table

(76) Inventors: Yun Shon Low, Richmond (CA); Peter Chia, Port Coquitlam (CA); Barton Pietras, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/621,837

(22) Filed: Jul. 17, 2003

(51) Int. Cl. G09G 5/00

(52) U.S. Cl. 345/211

(57) ABSTRACT

A graphics controller includes an interface for receiving and transmitting image data. A memory region in communication with the interface has a look-up table stored therein. The look-up table is configured to modify color tables which control an amount of data sent to a display screen, wherein the look-up table is programmable to correspond to a power level state of a power supply for the graphics controller. A device and a method for extending battery life for the device are also provided.

### BACKGROUND OF THE INVENTION

1. Field of the Invention

This invention relates generally to computer systems and more particularly to a method and apparatus for reducing power consumption for a battery operated display device by reducing the color display options.

2. Description of the Related Art

Portable electronic devices rely on batteries to provide the necessary power for the operation of the device. Consumers using the portable devices want to be able to use the devices for longer time periods in between having to recharge the batteries. As such, there is a continual effort to increase battery performance and to perform the operations consuming energy in more energy efficient ways, even as the applications and operations performed by the devices become more sophisticated, which in some cases, require more power. For example, cell phones, personal digital assistants (PDA's), etc., are moving to color display screens capable of displaying complex graphics at a high resolution. These devices require a considerable amount of power to present the display images. Additionally, the display of higher resolution images consumes more power. Thus, as portable devices having color are becoming more prevalent, the color display demands will require additional power.

One attempt to address the power concerns has been to identify sleep modes capable of limiting the power when the device is not being used. While sleep modes may cut back on power during non-usage periods, they do not address power consumption concerns while the device is being used. Furthermore, simply not driving the display would save considerable power but is not a viable alternative here as the user may desire to view the presentation during inactive periods.

Some devices allow a user to choose the brightness associated with the image being displayed on the display screen in order to reduce the amount of current being drawn. However, these devices do not address the color display function which is a major consumer of battery power for a battery operated electronic device.

As a result, there is a need to solve the problems of the prior art to provide a method and apparatus for adjusting the color resolution being displayed during periods of inactivity in order to extend the battery life for a portable electronic device.

### SUMMARY OF THE INVENTION

Broadly speaking, the present invention fills these needs by providing a programmable look-up table that is capable of re-programming the color tables to reduce the amount of data transferred to the display screen. It should be appreciated that the present invention can be implemented in numerous ways, including as a process, a system, or a device. Several inventive embodiments of the present invention are described below.

In one embodiment, a method for extending battery life for an electronic device is provided. The method initiates with determining an activity mode associated with a display panel. Then, a color display level is assigned based upon the activity mode. Next, image data is read from a memory. Then, the image data is presented at the color display level.

In another embodiment, a computer readable medium having program instructions for extending battery life for an electronic device is provided. The computer readable medium includes program instructions for determining an activity mode associated with a display panel. Program instructions for assigning a color display level based upon the activity mode and program instructions for reading image data from a memory display are provided. Program instructions for presenting the image data at the color display level are included.

In yet another embodiment, a graphics controller is provided. The graphics controller includes an interface for receiving and transmitting image data. A memory region in communication with the interface is included. The memory region has a look-up table stored therein. The look-up table is configured to modify color tables which control an amount of data sent to a display screen, wherein the look-up table is programmable to correspond to a power level state of a power supply for the graphics controller.

In still yet another embodiment, a device is provided. The device includes a central processing unit (CPU) and a display screen. A graphics controller in communication with the CPU and the display screen is included. The graphics controller includes an interface providing communication with the CPU. A memory region of the graphics controller is in communication with the interface. The memory region includes a look-up table stored therein. The look-up table is configured to limit an amount of data sent to a display screen from a color table associated with the look-up table, wherein the look-up table is configured to control the toggling of data lines to minimize power consumption.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram of the components of a device configured to save power through the use of a look-up table in accordance with one embodiment of the invention.

FIG. 2 is a simplified block diagram illustrating a look-up table update routine in accordance with one embodiment of the invention.

FIG. 3 is a simplified schematic diagram illustrating the interaction of an interrupt service routine in an operating system environment in order to periodically invoke the power saving features in accordance with one embodiment of the invention.

FIG. 4 is a flowchart diagram illustrating the method operations for reprogramming a look-up table in accordance with one embodiment of the invention.

FIG. 5 is a simplified schematic diagram illustrating an interrupt routine associated with an application in accordance with one embodiment of the invention.

FIG. 6 is a flow chart diagram illustrating the method operations for extending battery life for an electronic device in accordance with one embodiment of the invention.

### DETAILED DESCRIPTION OF THE PREFERRED EMBODIMENTS

An invention is described for an apparatus and method for limiting power consumption by limiting color component options through a look-up table (LUT). It will be apparent, however, to one skilled in the art in light of the following disclosure, that the present invention may be practiced without some or all of these specific details. In other instances, well known process operations have not been described in detail in order not to unnecessarily obscure the present invention.

The embodiments of the present invention provide a power saving system for a battery operated device having a display screen. The display screen is configured to operate in a power save mode while the screen is active, e.g., while a user has access to the image on the screen. In one embodiment, the active toggling data lines are reduced in order to achieve the power savings. By way of example, one such technique to achieve the power savings is to truncate a least significant bit of a color value in order to limit the choices available for each of the color components. Further power savings may be achieved by eliminating additional bits. In essence, color resolution is traded for power savings. In one embodiment, a look-up table provides the ability to reprogram color tables in order to modify the amount of data being transferred to a display panel.

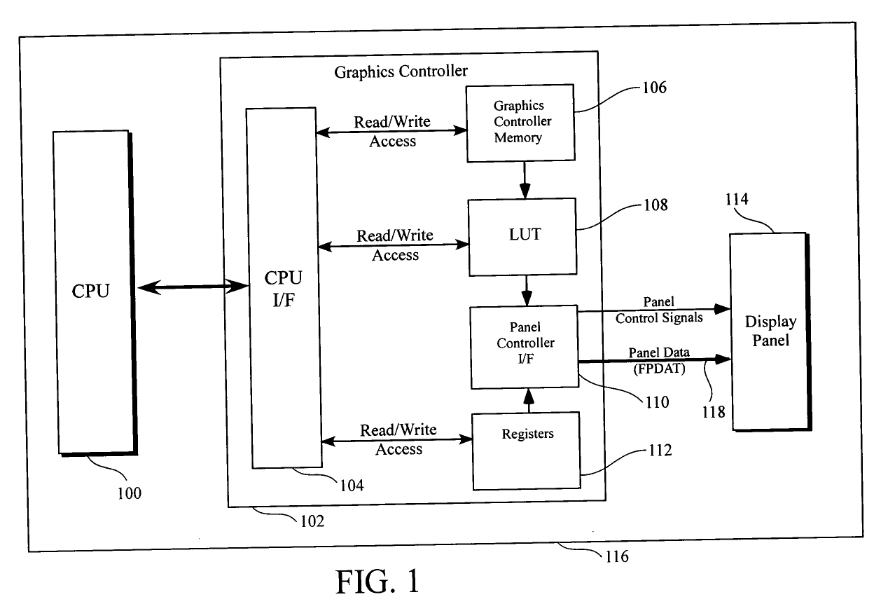

FIG. 1 is a simplified schematic diagram of the components of a device configured to save power through the use of a look-up table in accordance with one embodiment of the invention. Device 116 includes central processing unit (CPU) 100, graphics controller 102, and display panel 114. CPU 100 is in communication with graphics controller 102, which in turn is in communication with display panel 114. Graphics controller 102 includes the following modules: CPU interface 104, graphics controller memory 106 look-up table (LUT) 108, panel controller interface (I/F) 110, and registers 112. CPU interface 104 has read and write access to graphics controller memory 106, look-up table 108, and registers 112. Panel controller interface 110 is in communication with display panel 114. Accordingly, panel data and corresponding panel control signals are communicated between panel controller interface 110 and display panel 114. In one embodiment, display panel 114 is a liquid crystal display (LCD) panel. It should be appreciated that device 116 may be any suitable electronic portable device, e.g., a personal digital assistant (PDA), a web tablet, a cellular phone, a laptop computer, etc.

In one embodiment, LUT 108 is stored as a separate piece of memory, i.e., another memory instance, and acts as a translation table in addition to being the mechanism for implementing the color tables. As will be explained in more detail below, the programmability of LUT 108 enables less information to the transferred over panel data lines 118, thereby utilizing less energy both in the core and in the driver of the panel data lines. Additionally, the transfer of less information to display panel 114 may save energy in the display of the image data. Pixel data is fetched from graphics controller memory 106 and the data is translated to the appropriate color through LUT 108. The translated data is then directed to display panel 114 through panel controller I/F 110. It will be apparent to one skilled in the art that graphics controller memory 106 and LUT 108 may share the same memory. However, when graphics controller memory 106 and LUT 108 may share the same memory performance may suffer. It should be appreciated that graphics controller memory 106, LUT 108, and panel controller I/F 110 may be configured as a pipeline operation for each pixel to be displayed on display panel 114.

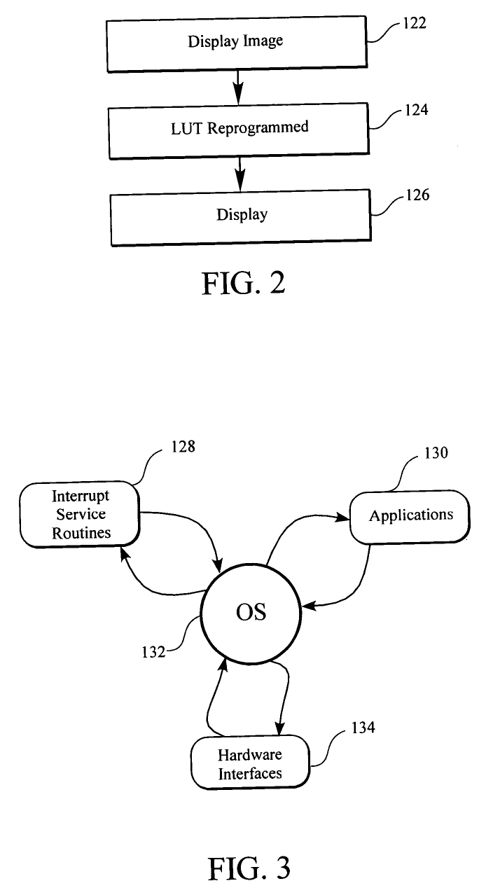

FIG. 2 is a simplified block diagram illustrating a look-up table update routine in accordance with one embodiment of the invention. In block 122, display image data is stored in memory. For example, software may write the display image data into display memory. Then, hardware may read one or two bytes out of the display memory. The data read out of memory then goes through the look-up table, i.e., LUT 108 with reference to FIG. 1. In one embodiment, the look-up table determines what to display on the display screen. Here, the look-up table may be re-programmed as illustrated by block 124. The re-programming enables a limit to be placed on the actual number of colors displayed. For example, as a power supply level is deteriorating and crosses a certain limit or threshold value, the number of colors being displayed on a display screen is simultaneously limited in order to further conserve the remaining power. The display image is then displayed on a display screen as designated by block 126.

It will be apparent to one skilled in the art that in one embodiment, the software controls the pace of the power save feature and enables the user to view an active display while this power save feature is actively conserving energy. In this embodiment, the software may allow the user to regulate how much color data is transferred to the display panel. The block diagram of FIG. 2 provides a look-up table update routine that enables the LUT to be applied at any time while leaving the detection of non-display periods to the graphics controller. It should be appreciated that the data written into the LUT is the color table. In one embodiment, a user may configure the power saving features described herein through a graphical user interface (GUI). For example, a GUI may be presented that allows a user to enable the power saving feature, as well as define characteristics associated with the power saving feature, e.g., define the amount of color reduction, time for invoking the interrupt service, etc.

FIG. 3 is a simplified schematic diagram illustrating the interaction of an interrupt service routine in an operating system environment in order to periodically invoke the power saving features in accordance with one embodiment of the invention. Here, operating system 132 interacts with interrupt service routines block 128, applications module 130, and hardware interfaces 134. Operating system 132 services interrupt service routines 128 periodically. For example, a timer may be used to periodically invoke the interrupt service routines 128. In one embodiment, the operating system is an operating system of a personal digital assistant that includes a timer and when there is no use of the PDA for certain periods of time, the operating system invokes interrupt service routines 128. That is, a signal indicating an interrupt is generated in order to possibly reprogram the look-up table based upon a period of inactivity. One skilled in the art will appreciate that operating system 132 may be any suitable operating system. In one embodiment, the longer the period of inactivity for the device, then the more time operating system 132 calls interrupt services routine 128 to change a look-up table so that fewer and fewer colors are displayed. Therefore, eventually, the screen may go blank after a certain period of inactivity.

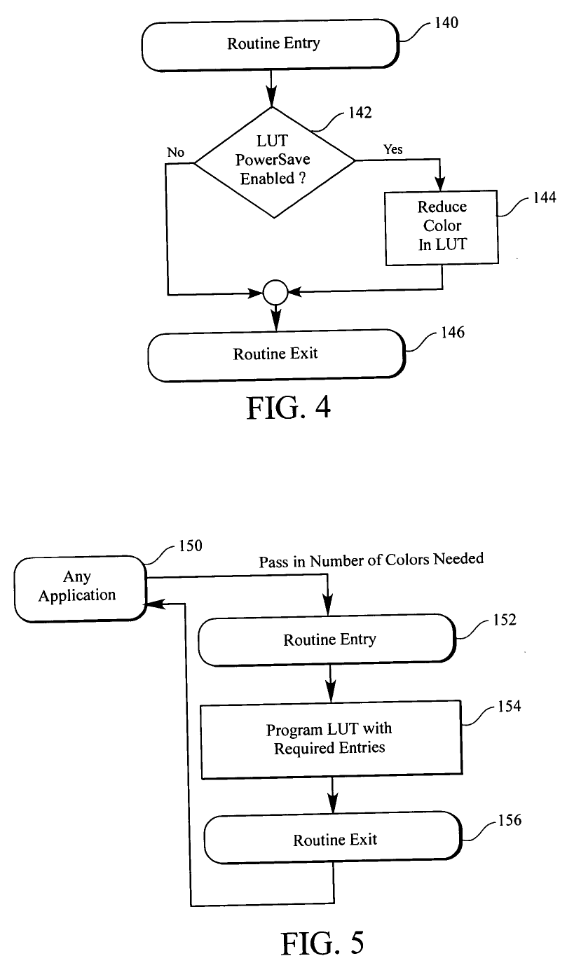

FIG. 4 is a flowchart diagram illustrating the method operations for reprogramming a look-up table in accordance with one embodiment of the invention. The method initiates with operation 140 where an interrupt services routine is initiated. Here, the interrupt services routine may be initiated in response to a timer or some other suitable monitoring feature as discussed above with reference to FIG. 3. The method then advances to decision operation 142 where it is determined if the look-up table power save mode is enabled. If look-up table power save mode is not enabled, the method advances to operation 146 where the routine exits. If the look-up table power save feature is enabled, then the method proceeds to operation 144 where color is reduced in the look-up table. In one embodiment, the look-up table is initially programmed to display a color table to reflect as much range as possible. With the implementation of the power save feature enabled, the software may actually program the look-up table to reflect as little range as possible, in accordance with one embodiment of the invention. One skilled in the art will appreciate that there are numerous suitable ways to implement reprogramming the look-up table to reflect as little range as possible.

In one embodiment, the range is limited by truncating the least significant bit (LSB) of a color value, i.e., an 18-bit color thin film transistor (TFT) panel will have six lines for red, green, and blue. The LUT can then be programmed not to toggle any data on the LSB of the three colors. Consequently, this will make the 18-bit panel into a 15-bit panel. In turn, reducing three toggling data lines will reduce power consumption. One skilled in the art will appreciate that 6 bits for each of the red (R), green (G), and blue (B), components, 2⁶, or 6⁴ different choices are available for each color component. These 64 choices cause the corresponding lines to toggle up and down frequently, thereby consuming a relatively large amount of power. By reducing the number of bits from 6 to 5, 4, 3, etc., then the choices are limited from 64, to 32, 16, 8, etc., respectively. Consequently, less toggling occurs, which results in less power being consumed.

In one embodiment, the number of bits are reduced by eliminating a least significant bit (LSB) or any other suitable number of bits associated with each color component. From operation 144 the method moves to operation 146 where the routine is exited. It should be appreciated that truncating the least significant bit is provided for illustrative purposes only and is not meant to be limiting. That is, the most significant bit of a color value may be truncated, or any combination of bits selected within the value may be truncated. Clearing the least significant bit would darken the displayed image slightly, while clearing the most significant bit would quickly darken the displayed image. In summation, the more bits that are cleared, the more power that is saved.

FIG. 5 is a simplified schematic diagram illustrating an interrupt routine associated with an application in accordance with one embodiment of the invention. Here, application 150 includes a trigger which passes in a number of colors needed for application 150. The trigger initiates the routine entry as designated in block 152. Then in response to entering the routine, the look-up table is programmed with the required entries in block 154. The LUT may be programmed to reduce the number of color choices by truncation of bits associated with the color choices as discussed above. Upon completion of programming the look-up table, the routine exits in block 156 and returns to application 150. Here, an application such as a word processing application, a spreadsheet application, and any other suitable application which does not require a high degree of colors, may include a trigger in which the look-up table is updated in order to save power.

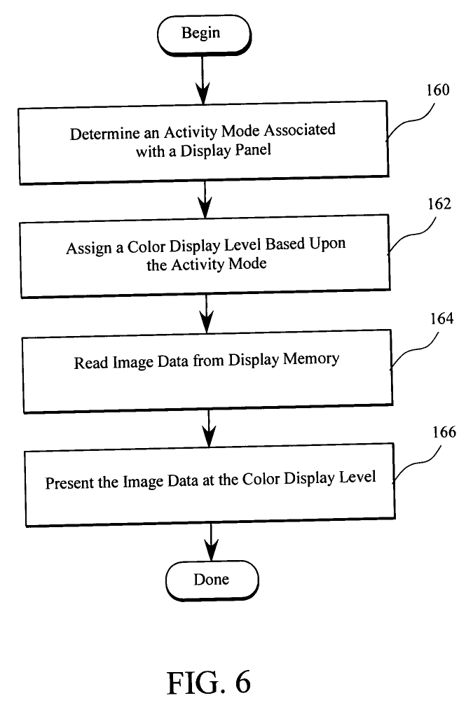

FIG. 6 is a flow chart diagram illustrating the method operations for extending battery life for an electronic device in accordance with one embodiment of the invention. The method initiates with operation 160 where an activity mode associated with a display panel is determined. Here, the activity mode may be an inactivity period which is determined through a timer, monitoring keyboard strokes, monitoring stylus input, or some other suitable monitoring scheme or means of identifying activity to determine whether data is being entered into or actively changed on a display panel or a device having a display panel. One skilled in the art will appreciate that the activity mode may have built in safeties to avoid going into power save mode. For example, a PDA which is playing a movie shouldn't go into power save mode even if the stylus has not been used recently. The activity mode may also be linked to the remaining available power level of the power supply driving the display panel. That is, the available power supply may be used to limit the colors displayed as the power supply deteriorates, thereby applying the power saving features of the LUT in an adaptive manner.

The method of FIG. 6 then advances to operation 162 where a color display level is assigned based upon the activity mode. For example, as discussed above, if a certain period of inactivity is detected, the corresponding color display level may be assigned to that period of inactivity. Thus, the least significant bit or a suitable number of bits may be truncated from a color value in order to reduce the toggling of data lines which correspondingly reduces power consumption as discussed with reference to FIG. 4. The method then moves to operation 164 where image data is read from display memory. For example, hardware reads one or two bytes out of display memory and what is read goes through a look-up table to determine what color display to be used. That is, the data is translated to the appropriate color by the LUT. The method then moves to operation 166 where the image data is presented at the color display level. For example, with reference to FIG. 1, the panel controller interface may transmit panel data and panel control signals to the corresponding display panel.

In summary, the embodiments described herein provide a power save mode which may be applied during active display/usage. The embodiments described herein may be applied to any suitable controller having look-up table capabilities. Additionally, the embodiments may be implemented on a variety of platforms and hardware. In one embodiment, the functionality of the method described herein may be downloaded in the form of a driver to a battery operated device. The driver may be downloaded through either a wireless or wired connection. Thus, the method may be implemented at the operating system level as a driver, as a stand alone program, or as any other suitable software form. By way of example, an application may implement the functionality described herein through the detection of an application running, wherein the application running does not need all of the color choices, e.g., a word processing application, a spread sheet application, etc. Alternatively, the application that does not need all of the color choices may provide a trigger that toggles the color choices through the look-up table.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for extending battery life for an electronic device, comprising:
determining an activity mode associated with a display panel;
assigning a color display level based upon the activity mode;
reading image data from a memory; and
presenting the image data at the color display level.

2. The method of claim 1, wherein the method operation of determining an activity mode associated with a display panel includes,
monitoring a time duration-of an inactivity period;
defining a limit for the time duration; and
initiating a routine to modify the color display level when the time duration reaches the limit.

3. The method of claim 1, wherein the method operation of determining an activity mode associated with a display panel includes,
monitoring an activity indicator selected from the group consisting of keystrokes, stylus input, remaining battery power, and inactivity duration.

4. The method of claim 1, wherein the method operation of assigning a color display level based upon the activity mode includes,
writing into a translation table to modify a number of color availability options.

5. The method of claim 4, wherein the method operation of writing into a translation table to modify a number of color availability options includes,
truncating a portion of a value associated with the color display level.

6. The method of claim 5, wherein the portion of the value is a least significant bit of a color value.

7. The method of claim 2, further comprising:
reducing data line toggling.

8. The method of claim 1, further comprising:
associating the image data with the color display level through a look-up table.

9. A computer readable medium having program instructions for extending battery life for an electronic device, comprising:
program instructions for determining an activity mode associated with a display panel;
program instructions for assigning a color display level based upon the activity mode;
program instructions for reading image data from a memory; and
program instructions for presenting the image data at the color display level.

10. The computer readable medium of claim 9, wherein program instructions for determining an activity mode associated with a display panel includes,
program instructions for monitoring a time duration of an inactivity period;
program instructions for defining a limit for the time duration; and
program instructions for initiating an interrupt routine to modify the color display level when the time duration reaches the limit.

11. The computer readable medium of claim 9, wherein the program instructions for determining an activity mode associated with a display panel includes,
program instructions for monitoring an activity indicator selected from the group consisting of keystrokes, stylus input, remaining battery power, and inactivity duration.

12. The computer readable medium of claim 9, wherein the program instructions for assigning a color display level based upon the activity mode includes,
program instructions for writing into a translation table to modify a number of color availability options.

13. The computer readable medium of claim 12, wherein the program instructions for writing into a translation table to modify a number of color availability options includes,
program instructions for truncating a portion of a value associated with the color display level.

14. The computer readable medium of claim 10, further comprising:
program instructions for reducing data line toggling.

15. A graphics controller, comprising:
an interface for receiving and transmitting image data; and
a memory region in communication with the interface, the memory region having a look-up table stored therein, the look-up table configured to modify color tables which control an amount of data sent to a display screen, wherein the look-up table is programmable to correspond to a power level state of a power supply for the graphics controller.

16. The graphics controller of claim 15, wherein the look-up table is capable of limiting the toggling of data lines by truncating a portion of a color value.

17. The graphics controller of claim 16, wherein the portion of the color value is one of a least significant bit of the color value and a most significant bit of the color value.

18. The graphics controller of claim 15, wherein the interface is capable of reading from and writing to the look-up table.

19. The graphics controller of claim 15, further comprising:
a display controller configured to communicate color data from the look-up table to a display device in communication with the display controller.

20. A device, comprising:
a central processing unit (CPU);
a display screen; and
a graphics controller in communication with the CPU and the display screen, the graphics controller including,
an interface providing communication with the CPU; and
a memory region in communication with the interface, the memory region having a look-up table stored therein, the look-up table configured to limit an amount of data sent to a display screen from a color table associated with the look-up table, wherein the look-up table is configured to control toggling of data lines to minimize power consumption.

21. The device of claim 20, further comprising:
a battery power supply.

22. The device of claim 20, further comprising:
data lines defined between the display screen and a display interface of the graphics controller, the data lines configured to provide color data from the graphics controller to the display screen, wherein a number of data lines utilized to provide the color data is limited as a power supply level decreases.

23. The device of claim 20, wherein the device is a portable electronic device.

24. The device of claim 23, wherein the portable electronic device is a device selected from the group consisting of a cellular phone, a web tablet, a personal digital assistant, and a laptop computer.
